(19) United States
(12) Patent Application Publication
(10) Pub. No.: US 2016/0140821 A1
(43) Pub. Date: May 19, 2016

(54) SYSTEM AND METHOD FOR REAL-TIME ASSET LOCALIZATION

(71) Applicants: Peyman Moeini, Toronto (CA); Xavier Fernando, Toronto (CA); Ik Pyo Hong, Toronto (CA)

(72) Inventors: Peyman Moeini, Toronto (CA); Xavier Fernando, Toronto (CA); Ik Pyo Hong, Toronto (CA)

(21) Appl. No.: 14/939,191

(22) Filed: Nov. 12, 2015

Related U.S. Application Data
(60) Provisional application No. 62/078,696, filed on Nov. 12, 2014.

(51) Int. Cl. G08B 13/24

(52) U.S. Cl. CPC G08B 13/2462

(57) ABSTRACT

A system for real-time asset localization. More particularly, the following relates to a high-speed clock that measures the time difference of arrival among signals received by nodes

### TECHNICAL FIELD

The following relates generally to real-time asset localization. More particularly, the following relates to high-resolution tamper-aware indoor tracking system.

### BACKGROUND

Localization technology can be applied to locate assets within a defined physical space in real-time. Such technology may be used in myriad spaces where locating assets (items or people, for example) with high accuracy is necessary. For example, hospitals, factories, mines, retail stores, farms, warehouses, schools, military organizations, secure facilities, emergency facilities, and various other locations may benefit greatly from being able to quickly and accurately locate assets.

There exist techniques for estimating the position of a communication device, or “tag”, coupled to an asset using direct communication with an established protocol. Many such techniques indirectly measure the distance between a tag and a device of known position.

Time difference of arrival (TDOA) methods apply a similar technique albeit by further comparing the propagation time arrival of a signal transmitted by a tag and received or detected by two or more devices of known position. Nevertheless, there continue to exist challenges for developing a fast and precise indoor localization system. For example, timing reference between the devices of known position and tags must be precise and method of synchronization is needed between the devices.

### SUMMARY

In one aspect, a system for locating an asset within a physical space, the system comprising: (a) a plurality of nodes; (b) a coordinator in communication with each node, the coordinator comprising a FPGA operable to output a clock and a 180 degree phase shifted clock, the coordinator generating a high speed clock comprised of an aggregation of the clock and the 180 degree phase shifted clock; and (c) a tag affixed to the asset, the tag operable to emit a beacon signal receivable by the plurality of nodes, the nodes each correspondingly communicating a respective timing signal to the coordinator, the coordinator configured to determine the time difference of arrival among the timing signals using the clock, the time difference of arrival corresponding to a distance from each node, and the coordinator mapping the distances to a position of the tag,

Corresponding methods are further provided.

### DESCRIPTION OF THE DRAWINGS

The features of the invention will become more apparent in the following detailed description in which reference is made to the appended drawings wherein:

FIG. 1 is a block diagram of an example of a system for real-time asset localization;

FIG. 2 is a timing diagram and a set of corresponding calculations illustrating the process of determining TDOA as part of the system;

FIG. 3 is a block diagram of an example of a coordinator used for real-time asset localization;

FIG. 4 is a close up view of the timing diagram previously shown in FIGS. 2; and

FIG. 5 is a flowchart illustrating the process of measuring the time difference of arrival among signals received by parts of the system.

### DETAILED DESCRIPTION

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth to provide a thorough understanding of the embodiments described herein. However, it will be understood by those of ordinary skill in the art that the embodiments described herein may be practised without these specific details. In other instances, well-known methods, procedures, and components have not been described in detail so as not to obscure the embodiments described herein. Also, the description is not to be considered as limiting the scope of the embodiments described herein.

The following provides a system and method for real-time asset localization. The system provides real-time asset localization with high-resolution applying a relative time difference of arrival determination. The system comprises a coordinator comprising a high-speed clock. In an embodiment, the coordinator is implemented by a field programmable gate array (FPGA).

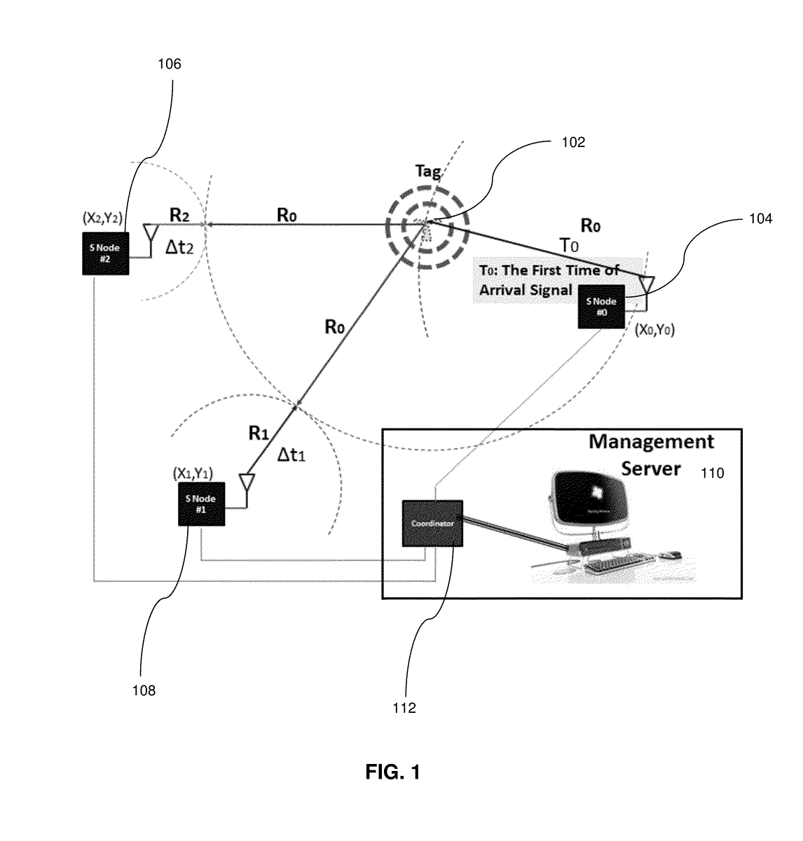

Referring now to FIG. 1, an exemplary system comprises a tag, a plurality of nodes and a management server comprising or in network communication with a coordinator. Tags are affixed or otherwise placed upon assets for which location tracking is needed. The tags are configured to broadcast a beacon signal that is receivable by nodes physically dispersed around a physical space.

As will be appreciated, physical location tracking of a space is best accomplished by distributing at least three nodes at physically separated locations in the space. Preferably, the nodes are located in proximity of boundary points of the space to increase location determination accuracy. The location of the nodes is known and the locations are stored such that they are accessible by the management server. In a further embodiment, the locations are stored such that they are accessible by the coordinator.

The nodes 104, 106, 108 are in network communication with the coordinator 112. Preferably, the network communication is provided by physical wire linking each node 104, 106, 108 to the coordinator 112, however a wireless connection is also possible. The nodes 104, 106, 108 are configured to transmit a timing signal to the coordinator 112 immediately following reception by the node of the beacon signal.

The coordinator 112 conducts a group synchronization of the nodes 104, 106, 108. The effect of synchronization is to configure the nodes 104, 106, 108 to transmit signals to the coordinator with a substantially identical delay, reducing relative timing inaccuracies associated with clock drift. Synchronization can be achieved in hardware. In one embodiment, each node 104, 106, 108 may be connected to the coordinator 112 via identically long wires. Thus, the signal delay from each node to the coordinator 112 would be substantially identical. In another embodiment, the coordinator 112 may comprise or be linked to a plurality of buffers, wherein each buffer is linked between the coordinator and one of the nodes, and provides a configurable delay to the signal being received from the node. The latter approach is suitable where the nodes 104, 106, 108 are linked wirelessly to the coordinator 112. Thus, the delays can be set so that timing signals are received from the nodes 104, 106, 108 with substantially the same delay.

The coordinator 112 receives the timing signals from the synchronized the nodes 104, 106, 108. The coordinator 112 determines the relative TDOA of the received timing signal and provides the determination to the management server 110, which determines the location of the asset. In a further embodiment, the coordinator may determine the location of the asset.

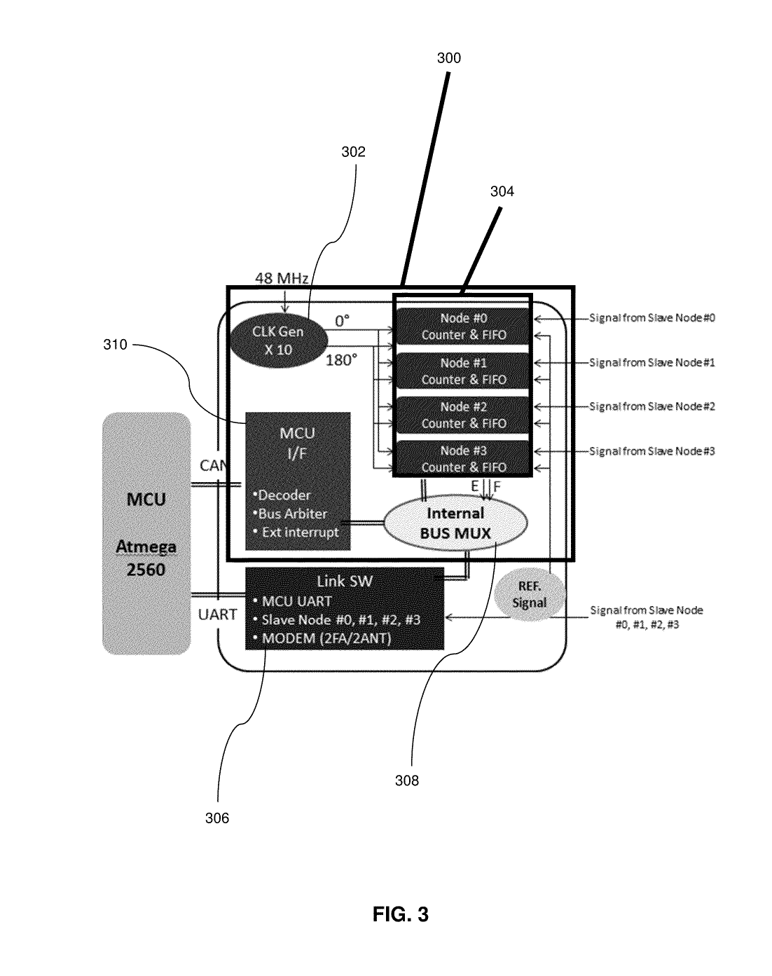

The coordinator 112 comprises a high speed clock 300 (Shown in FIG. 3, and discussed in more detail below). In the embodiment described herein, the high speed clock provides resolution in the range of nanoseconds. Hence, the high speed clock is alternately referred to herein as a “nano-counter”. The nano-counter is configured to generate a clock signal enabling the coordinator 112 to measure the TDOA among the timing signals received from the nodes 104, 106, 108, which correspond to the TDOA of the nodes 104, 106, 108 having received the beacon signal taking into account synchronization of the nodes 104, 106, 108. The TDOA determination is provided to the management server 110, which is configured to perform location determination using the TDOA of the signals to identify the position of a tag 102 and, therefore, an asset.

Referring in more detail now to the beacon signal, the tag comprises a signal generator linked to a RF transmitter (which, it will be appreciated, may include a modulator and other elements necessary to transmit a RF signal). The signal generator generates the beacon signal, which is transmitted by the RF transmitter.

Each node comprises a RF antenna, to receive RF signals, and RF receiver operable to receive, demodulate and decode a received RF signal. A propagated beacon signal is received at each node. The propagation time of the beacon signal is correlated to the distance between the node and the transmitting tag. It can be assumed that the signal travels at the speed of light, which is 3×10⁸ m/s.

In the example depicted in FIG. 1, the first node to receive the beacon signal is node #0 104, followed by node #2 106 and node #1 108. As shown, node #0 104 receives the beacon signal at time T0 while node #2 receives the beacon signal at time (T0+Δt2) and node #1 receives the beacon signal at time (T0+Δt1). Note that at the time of receiving the signals, the differences in time Δt are not actually known, but times are depicted in FIG. 1 as such for the reader's convenience.

Upon receiving the beacon signal, each node generates a timing signal and sends the timing signal to the coordinator 112. The coordinator 112 receives the timing signals, accounts for synchronization timing among the nodes, and determines the TDOA of the signals. The determination of TDOA is described in more detail below.

Once the TDOA is determined, the coordinator 112 determines the relative difference in distance of the asset to the nodes. Distance difference may be determined by multiplying the time difference by the velocity of the signal. It may be assumed that the beacon signal travels at the speed of light in a vacuum, c, which is approximately 3×10⁸ m/s, which is considered an acceptable approximation of the speed of light in air. Alternative value for speed of light could be substituted as desired.

Referring back to the example shown in FIG. 1, node #0 receives the beacon signal first. The time difference between reception of the beacon signal at node #1 to the reception of the signal at node #0 104 is Δt1 and the time difference between reception of the beacon signal at node #2 to the reception of the signal at node #0 104 is Δt2. Thus, the coordinator 112 determines distance R₁ (the difference in distance between the asset to node #0 and the asset to node #1) R₁=Δt1×c and R₂ (the difference in distance between the asset to node #0 and the asset to node #2) R₂=Δt2×c.

The coordinator 112 communicates R₁ and R₂ to the management server. Where the timing signal is first received from node #1, R₀ and R₂ will be communicated to the management server 110, and where the timing signal is first received from node #2, R₀ and R₁ will be communicated to the management server 110.

As the management server 110 has access to the known fixed locations of the nodes, which may be expressed as (X₀, Y₀), (X₁, Y₁) and (X₂, Y₂) for nodes 0, 1 and 2, respectively, the management 110 server can determine the position of the tag that transmitted the beacon signal. The determination may be made by trigonometrically solving for position using triangulation.

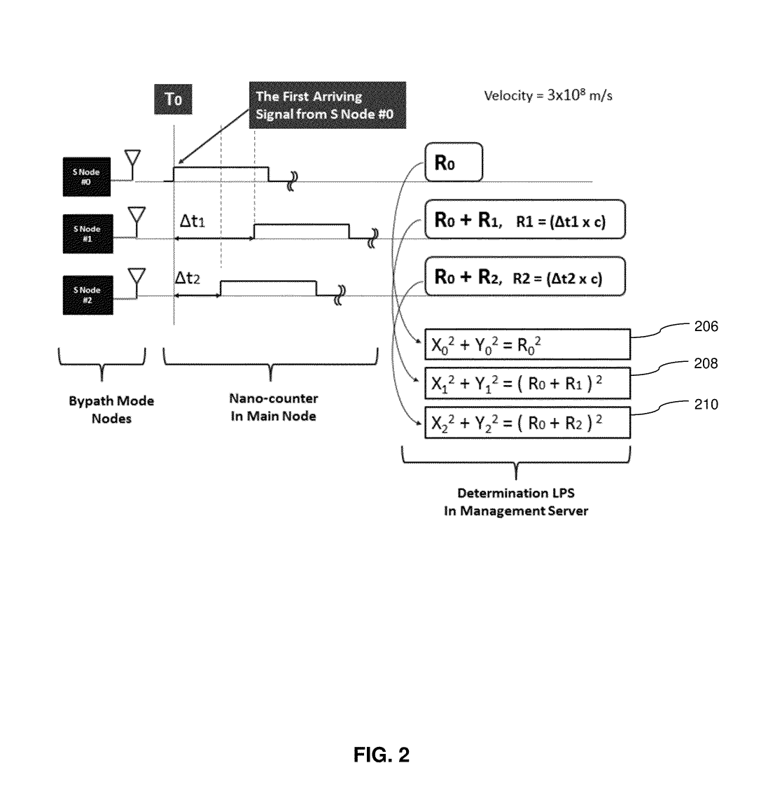

Referring now to FIG. 2, an exemplary timing diagram relating to timing signals received at the coordinator is shown. The coordinator monitors communications between itself and the nodes. Upon reception of a timing signal from any one of the nodes, the coordinator activates a timer, the nano-counter. The first received timing signal is allocated as the signal corresponding to the nearest node. As shown in FIG. 2, the first received signal is received from node #0 and, therefore, node #0 is the nearest node to the tag. Upon receiving the timing signal from node #0, the timer is activated.

The coordinator awaits reception of each subsequent timing signal from the other nodes. Upon reception of each such timing signal, the coordinator determines the amount of time that has elapsed since the timing signal was received from the nearest node. As shown in FIG. 2, the second node to have transmitted a timing signal is node #2 and the coordinator determines that Δt2 elapsed since receiving the timing signal from node #0. Similarly Δt1 elapses until a timing signal is received from node #1.

Thus, the coordinator has determined that node 0 is the closest node at distance R₀, node 2 the next closest at distance (R₀+R₂), and node 1 the furthest at distance (R₀+R₁) from the tag. These distance values are provided to the management server, which derives R₀ from the following three distance formulae:
X₀²+Y₀²=R₀² (206)
X₁²+Y₁²=(R₀+R₁)² (208)
X₂²+Y₂²=(R₀+R₂)² (210)

The management server knows R₁, R₂ and the three positions (X₀, Y₀), (X₁, Y₁) and (X₂, Y₂). Thus, the management server is able to determine a tag's location by resolving R₀ and subsequently identifying the point in the physical space that is a distance R₀ from node 0, (R₀+R₁) from node 1 and (R₀+R₂) from node 2.

Referring now to FIG. 3, an exemplary coordinator, comprising a nano-counter 300 is shown. The particular nano-counter 300 shown can be implemented using a FPGA. The coordinator comprises a nano-counter 300 and a switch 306. The nano-counter 300 comprises a digital clock generator 302, node counter 304, data bus MUX 308 and MCU 310. An internal speed of over 1 GHz for the FPGA is desirable for generating a nano-counter 300 of nanosecond resolution in this approach. A suitable example is Xilinx™ XC6SLX9-3TQG144C which supports at least 1 GHz internal speed.

The FPGA has an internal layout consisting of a plurality of node counters 304 each located substantially the same distance from the digital clock generator 302 to minimize jitter. The digital clock generator 302 provides flexible control over clock frequency and advanced clocking capabilities including a clock network, frequency synthesis and phase shift. The digital clock generator 302 comprises two pins: (1) generated clock output and (2) generated clock 180 degree phase shift signals. Each pin is coupled to a node counter 304 linked to one of the nodes. In FIG. 3, four node counters are shown for coupling to four nodes. It will be appreciated nodes and node counters may be added for increased reliability in calculation.

Each node counter implements a nano-counter that has a frequency of 20× of the input clock. The input clock is multiplied 10× by the FPGA's existing clock generator. The input clock should be at most 0.1 of the acceptable maximum node counter source clock where the clock generator is configured to multiply the input clock frequency by 10× In the example of Xilinx™ XC6SLX9-3TQG144C, the node counter source clock is not to exceed 500 MHz despite the internal speed capacity of 1 GHz. In an example, an input clock of 48 MHz can be provided to the node counter 304, which upconverts the clock to 480 MHz. The nano-clock outputs a clock signal of 960 MHz by doubling this frequency, which is closer to and better utilizes the capabilities of the FPGA.

At each node counter, the node counter is effectively doubled by sampling the clock pin and the 180° phase shift pin and considering either the rising or falling edge of each to be a clocking signal.

Each node counter further comprises a buffer, which is commonly a first input first output (FIFO) memory buffer. The digital clock generator 302 is preferably centrally located between the node counters such that counter propagation does not substantially differ between the node counters.

The node counter 304 for a node stores the RTDOA data of that node to corresponding buffer. Upon loading RTDOA data to the buffer, the node counter updates memory status information from FIFO empty to FIFO full. Stored FIFO data size will depend on communication baud rate between node and tag.

The MCU 310 monitors the FIFO status for all node counters and, when the buffer for a node is full, the MCU 310 reads the FIFO data via a bus arbiter. The data bus arbiter controls data flow within the MCU. Keep alive (KA) is sent between nodes and coordinator using an external interrupt signal. KA is a message sent by one device to another to check that the link between the two is operating, or to prevent this link from being broken. The MCU 310 prepares, registers, and commands FPGA internal registers. In further embodiments, the MCU 310 may read the status of KA via the data bus arbiter.

The internal bus MUX/DEMUX 308 is connected with an address map and an address decoder to direct data available on the FPGA via the address map. FIFO data, FIFO status, modem status, link control status, etc. stored on the FPGA, may be addressed by the internal bus MUX/DEMUX 308, read and stored on the FPGA. A data bus MUX 308 size of over 8 bits is desired.

The MCU 310 then converts data to distance. If FIFO presents an empty signal, the status becomes disabled by the MCU 310. Given three node locations and three relative distances, tag location may be identified by the management server using the method discussed above.

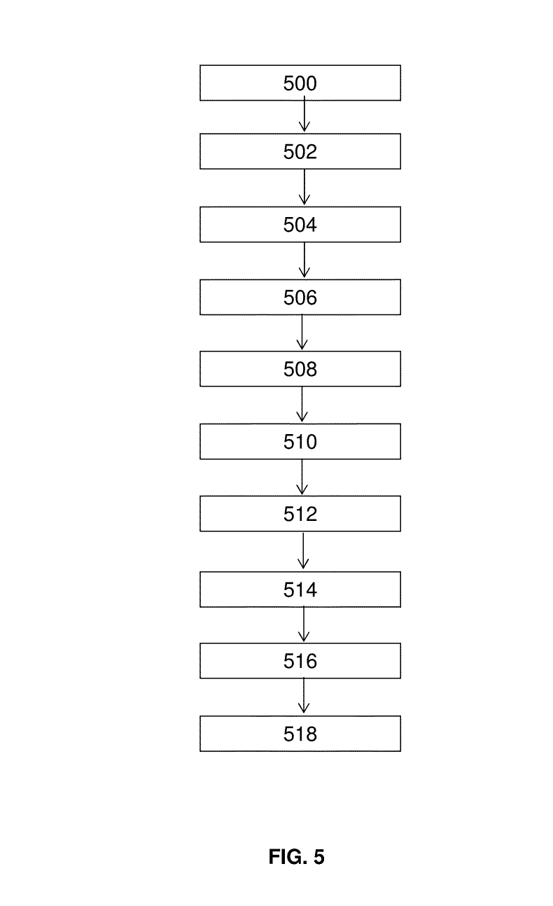

For increased clarity, FIG. 5 provides a flowchart illustrating the process of the system determining relative distances. At block 500, each node sends a beacon signal. At block 502, the nodes receive the beacon signal and generates a timing signal. At block 504, the nodes send the timing signals to the controller. At block 506 each node counter measures RTDOA signals from respective nodes. At block 508, the node counter stores RTDOA data to the buffer. At block 510, the MCU reads stored buffer information signals and buffer data via the bus arbiter. At block 512, the MCU prepares, registers, and commands FPGA internal registers. At block 514, the internal bus MUX/DEMUX directs available data required for distance determination by the MCU. The MCU converts data to distance at block 516. At block 518, the management server identifies the location of the tag.

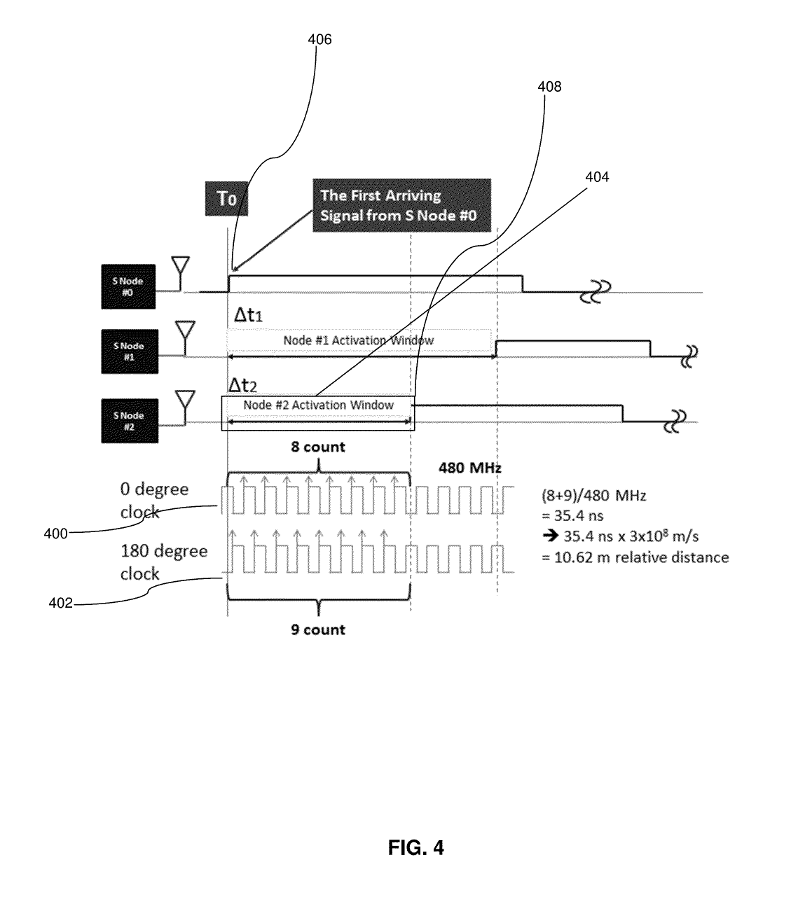

Referring now to FIG. 4, a close up view of the timing diagram previously shown in FIG. 2 is shown. Each node counter measures RTDOA signals during activation windows (the time between receiving the first timing signal and the currently-awaited timing signal) for the respective node, such as Δt2 for node 2, using two clocks, one a source clock (at 0 degrees) 400 and the other a 180 degree phase shifted clock 402 In this example, the node counter is measuring Δt2 which is the RTDOA signal of node #2. In this example, 8 periods are measured with a 0 degree clock whereas 9 periods are measured with 180 degree clock. As noted above, the clock frequency of the digital clock generator is 480 MHz from the clock generator. When the activation window is closed, the counter may sum two periods of 8 and 9 above to arrive at 17 periods. Δt2 may then be determined as 35.4 ns, 17× 1/480 MHz. RTDOA is 35.4 ns which corresponds to 10.62 m. Thus, the node #0 is 10.62 m closer to the tag than node #2.

The node counter may similarly determine RTDOA for node 1 (Δt1) and corresponding distance using the same method as above. Δt2−Δt1 is the difference in time between node #1 and node #2.

Although the following has been described with reference to certain specific embodiments, various modifications thereto will be apparent to those skilled in the art without departing from the spirit and scope of the invention as outlined in the appended claims. The entire disclosures of all references recited above are incorporated herein by reference.

We claim:

1. A system for locating an asset within a physical space, the system comprising:
a. a plurality of nodes;
b. a coordinator in communication with each node, the coordinator comprising a FPGA operable to output a clock and a 180 degree phase shifted clock, the coordinator generating a high speed clock comprised of an aggregation of the clock and the 180 degree phase shifted clock;
c. a tag affixed to the asset, the tag operable to emit a beacon signal receivable by the plurality of nodes, the nodes each correspondingly communicating a respective timing signal to the coordinator, the coordinator configured to determine the time difference of arrival among the timing signals using the clock, the time difference of arrival corresponding to a distance from each node, and the coordinator mapping the distances to a position of the tag,
